(19) United States
(12) Patent Application Publication
(10) Pub. No.: US 2026/0275145 A1
(43) Pub. Date: Sep. 17, 2026

(54) ECO-FRIENDLY ANTI-ICING COATING COMPOSITION INCLUDING SWITCHABLE HYDROPHILIC-HYDROPHOBIC COPOLYMER AND METHOD FOR PREPARING THE SAME

(71) Applicant: PUSAN NATIONAL UNIVERSITY INDUSTRY-UNIVERSITY COOPERATION FOUNDATION, Busan (KR)

(72) Inventors: Chae Bin KIM, Busan (KR); Se Hui AN, Busan (KR)

(73) Assignee: PUSAN NATIONAL UNIVERSITY INDUSTRY-UNIVERSITY COOPERATION FOUNDATION, Busan (KR)

(21) Appl. No.: 19/348,309

(22) Filed: Oct. 2, 2025

(30) Foreign Application Priority Data
Mar. 13, 2025 (KR) 10-2025-0032542

(51) Int. Cl. C09D 125/08; C09D 7/61

(52) U.S. Cl. CPC C09D 125/08; C09D 7/61

(57) ABSTRACT

An eco-friendly anti-icing coating composition includes a switchable hydrophilic-hydrophobic copolymer, which includes a styrene-maleic anhydride switchable hydrophilic-hydrophobic copolymer between hydrophilic and hydrophobic, enabling an eco-friendly coating using water as a solvent while simultaneously exhibiting excellent waterproofing properties and durability. A method for preparing the eco-friendly anti-icing coating composition includes: preparing a styrene-maleic anhydride (SMA) copolymer; preparing a copolymer mixture by mixing the SMA copolymer and graphene oxide (GO); and preparing a coating composition by adding an alcohol to the copolymer mixture.

### CROSS-REFERENCE TO PRIOR APPLICATION

This application claims priority to Korean Patent Application No. 10-2025-0032542 (filed on Mar. 13, 2025), which is hereby incorporated by reference in its entirety.

### BACKGROUND

The present invention relates to an eco-friendly anti-icing coating composition including a switchable hydrophilic-hydrophobic copolymer and a method for producing the same, and more particularly, to an eco-friendly anti-icing coating composition including a switchable hydrophilic-hydrophobic copolymer, which includes a styrene-maleic anhydride switchable hydrophilic-hydrophobic copolymer between hydrophilicity and hydrophobicity, and which enables an eco-friendly coating using water as a solvent while exhibiting excellent waterproofing properties and durability, and a method for preparing the same.

Hydrophobic coatings minimize contact with water on a surface, allowing water droplets to remain spherical and easily roll off without spreading. Hydrophobic coatings increase the water contact angle, preventing water from seeping in or pooling on the surface. Hydrophobic coatings also protect the surface from water, moisture, and contaminants, preventing damage and aging and improving durability and functionality. Furthermore, the above-described properties, along with their self-cleaning properties, prevent contaminants from sticking to the surface and even enabling the removal of the contaminants along with water droplets, thereby reducing maintenance costs and maintaining a hygienic environment.

Furthermore, hydrophobic coatings are used to form air pockets between a coated substrate and water droplets to reduce thermal conductivity and decrease the contact area between the water droplets and the surface, thereby delaying icing in low-temperature environments. For example, hydrophobic coatings can be used to prevent performance degradation and damage when ice forms on aircraft wings, wind turbine blades, and power lines, where ice formation frequently occurs. The demand and application of these hydrophobic coatings are increasing across industries, as they offer substantial performance while minimizing manufacturing costs.

Hydrophobic coatings include hydrophobic organic coatings that are based on hydrophobic polymers dissolved in organic solvents for application and water-based coatings that are based on hydrophilic polymers dissolved in water for application.

Coatings manufactured using silicone and fluorinated polymers dissolved in organic solvents such as hexene and toluene offer excellent durability and water resistance. However, they require large amounts of organic solvents during the manufacturing and cleaning processes, and thus they have limitations in terms of stability and environmental protection and cause high costs. Furthermore, with the recent global expansion of regulations on fluorine-containing chemicals, such as perfluorinated compounds, demand for non-fluorinated, eco-friendly hydrophobic coatings is rapidly increasing.

Due to the above-described issues, research on water-based coatings based on hydrophilic polymers has been actively conducted in recent years. Water-based coatings based on hydrophilic polymers offer the advantage of using water as a solvent, enhancing the eco-friendliness of the process. However, the use of hydrophilic polymers, such as polyvinyl alcohol (PVA), requires the addition of additives and cross-linkers to improve performance. Furthermore, these coatings, due to their inherent hydrophilic nature, are vulnerable to water, making them susceptible to peeling in rainy or humid environments.

Due to the above-described limitations, the development of coating compositions including a switchable hydrophilic-hydrophobic copolymer capable of switching between hydrophilicity and hydrophobicity of the polymer itself is urgently needed.

### SUMMARY

To overcome the above-described limitations, the present invention provides an eco-friendly anti-icing coating composition including a switchable hydrophilic-hydrophobic copolymer capable of switching between hydrophilicity and hydrophobicity of the polymer itself, and a method for preparing the same.

In addition, an object of the present invention is to provide an eco-friendly anti-icing coating composition that is in a hydrophilic state during a coating process and thus readily dissolves in water, enabling an eco-friendly and simple process, after which functional groups are converted into hydrophobic functional groups to exhibit excellent waterproofing properties and durability, and a method of preparing the same.

In addition, another object of the present invention is to provide an eco-friendly anti-icing coating composition that includes graphene oxide (GO) and thus exhibits a photothermal effect of increasing temperature by absorbing light to exhibit excellent anti-icing performance, and a method for preparing the same.

The technical problems to be solved by the present invention are not limited to those mentioned above, and other technical problems that are not mentioned above will be clearly understood by those skilled in the art from the description of the present invention.

In order to achieve the above-described objects, the present invention provides an eco-friendly anti-icing coating composition including a switchable hydrophilic-hydrophobic copolymer, the composition including: a styrene-maleic anhydride (SMA) copolymer including styrene and maleic anhydride; and GO.

In the present invention, the SMA copolymer is represented by the following [Chemical Formula 1]:

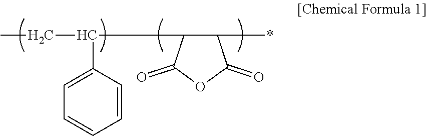

In the present invention, the SMA copolymer includes the styrene and the maleic anhydride in a molar ratio of 1 to 4:1.

In the present invention, the SMA copolymer reversibly exhibits a ring-opening reaction and a ring-closing reaction.

In the present invention, the ring-opening reaction occurs when the coating composition is added to a basic solution and stirred.

In the present invention, the ring-closing reaction occurs when the coating composition is heated at 180 to 220° C. for three to seven minutes.

In the present invention, the coating composition includes 0.5% to 10% by weight of the GO based on 100% by weight of the coating composition.

The present invention provides a method for preparing an eco-friendly anti-icing coating composition including a switchable hydrophilic-hydrophobic copolymer, the method including: a step of preparing a styrene-maleic anhydride (SMA) copolymer; a step of preparing a copolymer mixture by mixing the SMA copolymer and GO; and a step of preparing a coating composition by adding an alcohol to the copolymer mixture.

In the present invention, the step of preparing the SMA copolymer includes: a step of preparing a reaction solution by adding styrene, maleic anhydride, and an initiator to a polar organic solvent and then heating and stirring; a step of purifying unreacted monomers by precipitating the reaction solution in an alcohol; a step of obtaining an SMA copolymer by filtering the reaction solution purified from unreacted monomers; and a step of drying the SMA copolymer.

In the present invention, the polar organic solvent is tetrahydrofuran (THF), and the initiator is azobisisobutyronitrile (AIBN).

In the present invention, in the step of preparing the reaction solution, the styrene and the maleic anhydride are added in a molar ratio of 1 to 4:1 and then heated and stirred.

In the present invention, in the step of preparing the reaction solution, heating is performed to 60 to 80° C. and stirring is performed for 22 to 26 hours.

In the present invention, in the step of purifying unreacted monomers by precipitating the reaction solution in an alcohol, the reaction solution is precipitated in an alcohol in a weight ratio of 1:3 to 5.

In the present invention, in the step of drying the SMA copolymer, heating is performed at 40 to 60° C. for 13 to 17 hours.

In the present invention, in the step of preparing a copolymer mixture by mixing the SMA copolymer and GO, 0.5% to 10% by weight of the GO is mixed based on 100% by weight of the copolymer mixture.

In the present invention, the step of preparing a copolymer mixture by mixing the SMA copolymer and GO includes: a step of preparing a dispersion by adding GO to water and then dispersing; and a step of adding the SMA copolymer and a basic solution to the dispersion and then stirring and dispersing.

In the present invention, in the step of adding the SMA copolymer and a basic solution to the dispersion and then stirring and dispersing, the basic solution is added in a weight ratio of 1:0.3 to 0.9 based on the water.

In the present invention, in the step of preparing a coating composition by adding an alcohol to the copolymer mixture, the alcohol is added in a weight ratio of 1:0.8 to 1.2 based on the water.

### BRIEF DESCRIPTION OF THE DRAWINGS

The accompanying drawings are intended to explain the contents of the present invention in more details to those skilled in the art, but the technical principle of the present invention is not limited thereto.

FIG. 1 is a diagram showing the results of ¹H-NMR measurement of a styrene-maleic anhydride (SMA) copolymer according to an embodiment of the present invention.

FIG. 2 is a diagram showing the results of thermogravimetric analysis (TGA) of an SMA copolymer according to an embodiment of the present invention.

FIG. 3 is a diagram showing the results of differential scanning calorimetry (DSC) of an SMA copolymer according to an embodiment of the present invention.

FIG. 4 is a diagram showing the results of Fourier-transform infrared spectroscopy (FT-IR) of an SMA copolymer according to an embodiment of the present invention after a ring-opening reaction and a ring-closing reaction.

FIG. 5 is a diagram showing the results of a water-solubility analysis experiment of an SMA copolymer according to an embodiment of the present invention.

FIG. 6 is a diagram showing the results of a contact angle analysis experiment of an SMA copolymer according to an embodiment of the present invention after a ring-opening reaction.

FIG. 7 is a diagram showing the results of a contact angle analysis experiment of an SMA copolymer according to an embodiment of the present invention (a) before a ring-opening reaction and (b) after a ring-closing reaction.

FIG. 8 is a diagram showing the results of FT-IR of an anti-icing coating composition according to an embodiment of the present invention.

FIG. 9 is a diagram showing the results of TGA of a film containing a coating solution according to an embodiment of the present invention.

FIG. 10 is a diagram showing the results of DSC of a film containing a coating solution according to an embodiment of the present invention.

FIG. 11 is a diagram showing the results of a pencil hardness test of a coating containing a coating solution according to an embodiment of the present invention.

FIG. 12 is a diagram showing the results of a photothermal test of a coating containing a coating solution according to an embodiment of the present invention.

FIG. 13 is a diagram showing the results of an analysis of the icing occurrence time of a coating containing a coating solution according to an embodiment of the present invention in the absence of light.

FIG. 14 is a diagram showing the results of an analysis of the icing occurrence time of a coating containing a coating solution according to an embodiment of the present invention in the presence of light.

FIG. 15 is a diagram showing the results of UV-VIS spectroscopy measurements of a coating containing a coating solution according to an embodiment of the present invention before and after immersion in distilled water.

### DETAILED DESCRIPTION

The terms used herein are selected as general terms that are currently widely used as much as possible while considering the functions in the present invention, but they may vary depending on the intention of those of ordinary skill in the art, precedents, the emergence of new technology, or the like. In addition, in certain cases, there are terms arbitrarily selected by the applicant, and in this case, the meaning will be described in the corresponding part of the detailed description of the invention. Therefore, the terms used in the present invention should be defined based on the meaning of the terms and the overall content of the present invention, rather than simply the names of the terms.

Unless otherwise defined, all terms, including technical and scientific terms used herein, have the same meaning as generally understood by one of ordinary skill in the art to which the present invention pertains. Terms, such as those defined in commonly used dictionaries, should be interpreted as having a meaning that is consistent with their meaning in the context of the relevant art and are not interpreted in an idealized or overly formal sense unless explicitly defined in the present invention.

Numerical ranges are inclusive of the values defined therein. Every maximum numerical limitation given throughout the present specification includes every lower numerical limitation, as if such lower numerical limitations were expressly written. Every minimum numerical limitation given throughout the present specification includes every higher numerical limitation, as if such higher numerical limitations were expressly written. Every numerical limitation given throughout the present specification will include every better numerical range within the broader numerical range, as if the narrower numerical limitations were expressly written.

An eco-friendly anti-icing coating composition including a switchable hydrophilic-hydrophobic copolymer

The present invention relates to an eco-friendly anti-icing coating composition including a switchable hydrophilic-hydrophobic copolymer.

The present invention relates to an eco-friendly anti-icing coating composition including a switchable hydrophilic-hydrophobic copolymer, the composition including: a styrene-maleic anhydride (SMA) copolymer including styrene and maleic anhydride; and graphene oxide (GO).

The eco-friendly anti-icing coating composition combines a photothermal effect with a hydrophobic anti-icing coating technology, exhibiting properties that allow for not only delaying icing but also melting existing ice and easily removing it from the surface, which can simplify maintenance work and improve efficiency in extreme environments.

The SMA copolymer including styrene and maleic anhydride may be capable of switching the hydrophilicity and hydrophobicity of the polymer itself. More specifically, it may include styrene, which exhibits a high glass transition temperature and strength, and maleic anhydride, which is capable of controlling hydrophilicity and hydrophobicity, as monomers. A ring-opening reaction of maleic anhydride may be induced by using a basic solution to introduce carboxylic acid, which is a hydrophilic functional group, thereby enabling an eco-friendly coating using water as a solvent. In addition, heating may induce a ring-closing reaction, converting the carboxylic acid back into an anhydride group, which is a hydrophobic functional group, thereby imparting waterproofing properties and durability.

The GO forms a strong physical bond through hydrogen bonding and electrostatic interaction with the polymer chain through various oxygen-containing functional groups including —OH and —COOH contained in the GO, so that the thermal decomposition temperature of the coating is increased, through which excellent high-temperature stability and a high thermal decomposition temperature of the coating can be exhibited, improving the thermal and mechanical properties of the coating. More specifically, the GO can exhibit a photothermal effect by absorbing light through its large surface area and high light absorption properties to increase the temperature, thereby enhancing the anti-icing performance, and through this, it may be possible to prevent icing and control the anti-icing performance in extreme environments.

In addition, due to the planar structure and strong bonding of the GO, movement between polymer chains may be further suppressed, resulting in a high glass transition temperature, thereby exhibiting excellent heat resistance and mechanical strength.

The coating composition may be formed by bonding the carboxylic acid group of maleic acid, which has undergone a ring-opening reaction in the SMA copolymer, to the hydroxyl group of the GO through an esterification reaction.

In the present invention, the SMA copolymer may be represented by the following [Chemical Formula 1].

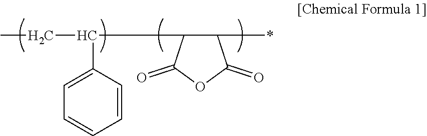

The SMA copolymer may be a combination of styrene and maleic anhydride as shown in [Chemical Formula 1]. The styrene has a nonpolar bond within the molecule that increases temperature resistance and thus remains stable even at high temperatures. When the alkyl group of the styrene is bonded to the polymer chain, it may increase the heat resistance and decomposition temperature of the polymer and improve thermal stability.

In the present invention, the SMA copolymer may include styrene and maleic anhydride in a molar ratio of 1 to 4:1. Styrene is a non-polar substance that repels water droplets from the surface and enhances the hydrophobicity of the surface. Maleic anhydride is a polar substance that tends to bind well to water through hydrogen bonding and electrostatic interactions within the polymer chain, thereby enhancing the hydrophilicity. Therefore, the hydrophobicity and hydrophilicity of the polymer can be controlled depending on the ratio of styrene and maleic anhydride.

In addition, due to the maleic anhydride that has a polar structure compared to the styrene, which has a nonpolar structure, the SMA copolymer has increased hydrogen bonding and electrostatic interactions, resulting in a dense arrangement between polymer chains and reduced chain mobility, further suppressing movement of molecular chains. As a result, the glass transition temperature increases as the molar ratio of maleic anhydride increases, and thus, the SMA copolymer may exhibit excellent heat resistance and mechanical stability.

When the maleic anhydride is included in an amount exceeding the above-described range, the SMA copolymer may be unstable at high temperatures and have high chemical reactivity, which may cause problems such as easy decomposition at high temperatures. When the styrene is included in an amount less than the above-described range, the temperature resistance of the copolymer may be reduced, resulting in problems such as lower thermal stability and a lower decomposition temperature.

In the present invention, the SMA copolymer may reversibly exhibit ring-opening and ring-closing reactions. This allows the SMA copolymer to be capable of switching between hydrophilicity and hydrophobicity.

A ring-opening reaction of maleic anhydride using ammonia water may be induced to introduce carboxylic acid, which is a hydrophilic functional group, enabling an eco-friendly coating using water as a solvent. When the copolymer is heated to a high temperature, a ring-closing reaction converts the carboxylic acid into an anhydride group, which is a hydrophobic functional group, thereby improving waterproofing properties and durability.

The ring-opening reaction and the ring-closing reaction may be represented as shown in [Scheme 1] below.

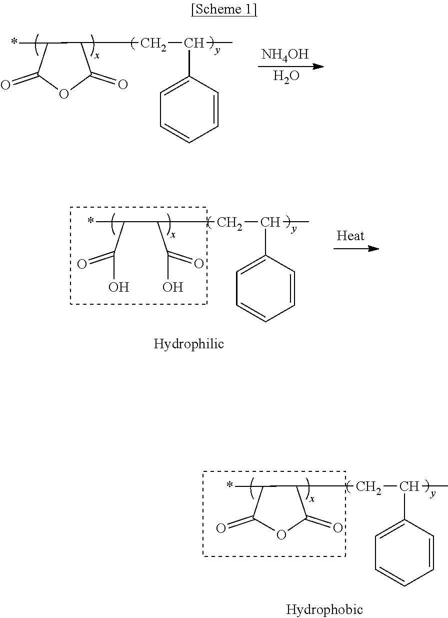

In the present invention, the ring-opening reaction may occur when the coating composition is added to a basic solution and stirred. When the ring-opening reaction occurs, maleic anhydride included in the copolymer may be converted to maleic acid. Before the ring-opening reaction is induced, maleic anhydride included in the copolymer exhibits hydrophobicity when it has a cyclic structure, so it does not dissolve in water. However, after the ring-opening reaction is induced, it is converted to a maleic acid form, generating a hydrophilic functional group, thereby exhibiting hydrophilicity and easily dissolving in water.

In the present invention, the ring-closing reaction may occur when the coating composition is heated at 180 to 220° C. for three to seven minutes. When the ring-closing reaction occurs, the maleic acid that has been converted by the ring-opening reaction may be reconverted into maleic anhydride.

In the present invention, the coating composition may include 0.5% to 10% by weight of the GO based on 100% by weight of the coating composition. As the content of the GO increases, various oxygen-containing functional groups, including —OH and —COOH, included in the GO may form stronger physical bonds through hydrogen bonding and electrostatic interactions with polymer chains, thereby increasing the thermoelectric decomposition temperature of the coating. In addition, more esterification reactions may occur, resulting in stronger chemical interactions with the polymers contained in the composition, thereby improving high-temperature stability. In addition, due to the high light absorption properties of GO, the higher the content of the GO, the more light may be absorbed, thus generating more heat.

When the GO is included in an amount exceeding 10% by weight, the viscosity of the coating composition may increase, making the coating process difficult. When the GO is included in an amount less than 0.5% by weight, the bonding with the polymer may become weak, and the photothermal effect may also be reduced.

Method for preparing an eco-friendly anti-icing coating composition including a switchable hydrophilic-hydrophobic copolymer

The present invention relates to a method for preparing an eco-friendly anti-icing coating composition including a switchable hydrophilic-hydrophobic copolymer.

The present invention relates to a method for preparing an eco-friendly anti-icing coating composition including a switchable hydrophilic-hydrophobic copolymer, the method including: a step of preparing an SMA copolymer; a step of preparing a copolymer mixture by mixing the SMA copolymer and GO; and a step of preparing a coating composition by adding an alcohol to the copolymer mixture.

The preparation method may be a method of preparing a coating composition capable of converting an anhydride into a hydrophilic functional group using a base and then converting it to a hydrophobic functional group by applying heat.

An anti-icing coating prepared according to the preparation method may be an eco-friendly anti-icing coating composition including a switchable hydrophilic-hydrophobic copolymer, the composition including: an SMA copolymer including styrene and maleic anhydride; and GO. The eco-friendly anti-icing coating composition combines a photothermal effect with a hydrophobic anti-icing coating technology to exhibit properties that allow for not only delaying icing but also melting existing ice and easily removing it from the surface, which can simplify maintenance work and improve efficiency in extreme environments.

In the present invention, the step of preparing the SMA copolymer may include: a step of preparing a reaction solution by adding styrene, maleic anhydride, and an initiator to a polar organic solvent and then heating and stirring; a step of purifying unreacted monomers by precipitating the reaction solution in an alcohol; a step of obtaining an SMA copolymer by filtering the reaction solution purified from unreacted monomers; and a step of drying the SMA copolymer.

The step of preparing the SMA copolymer may be represented by the following [Scheme 2].

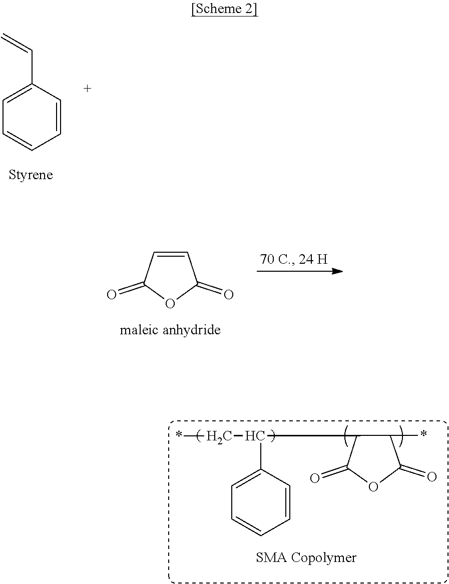

The SMA copolymer prepared through the above-described reaction may be a combination of styrene and maleic anhydride. The intramolecular nonpolar bonds of the styrene enhance temperature resistance, maintaining stability even at high temperatures. When the alkyl group of the styrene is bonded to the polymer chain, the heat resistance and decomposition temperature of the polymer increase, enhancing thermal stability.

In addition, the SMA copolymer including styrene and maleic anhydride may be capable of switching the hydrophilicity and hydrophobicity of the polymer itself. More specifically, it may include styrene, which exhibits a high glass transition temperature and strength, and maleic anhydride, which is capable of controlling hydrophilicity and hydrophobicity, as monomers. A ring-opening reaction of maleic anhydride may be induced by using a basic solution to introduce carboxylic acid, which is a hydrophilic functional group, thereby enabling an eco-friendly coating using water as a solvent. In addition, heating may induce a ring-closing reaction, converting the carboxylic acid back into an anhydride group, which is a hydrophobic functional group, thereby imparting waterproofing properties and durability.

In the present invention, the polar organic solvent is tetrahydrofuran (THF), and the initiator is azobisisobutyronitrile (AIBN).

In the present invention, in the step of preparing the reaction solution, the styrene and the maleic anhydride may be added in a molar ratio of 1 to 4:1 and then heated and stirred. Styrene is a nonpolar substance that repels water droplets from surfaces, enhancing surface hydrophobicity. Maleic anhydride is a polar substance that readily binds to water through hydrogen bonding and electrostatic interactions within the polymer chain. This enhances hydrophilic properties, making it possible to control hydrophobicity and hydrophilicity of a polymer by varying the ratio of styrene to maleic anhydride.

In addition, due to the maleic anhydride that has a polar structure compared to the styrene, which has a nonpolar structure, the SMA copolymer has increased hydrogen bonding and electrostatic interactions, resulting in a dense arrangement between polymer chains and reduced chain mobility, further suppressing movement of molecular chains. As a result, the glass transition temperature increases as the molar ratio of maleic anhydride increases, and thus, the SMA copolymer may exhibit excellent heat resistance and mechanical stability.

When the maleic anhydride is included in an amount exceeding the above-described range, the SMA copolymer may be unstable at high temperatures and have high chemical reactivity, which may cause problems such as easy decomposition at high temperatures. When the styrene is included in an amount less than the above-described range, the temperature resistance of the copolymer may be reduced, resulting in problems such as lower thermal stability and a lower decomposition temperature.

In the present invention, in the step of preparing the reaction solution, heating may be performed to 60 to 80° C. and stirring is performed for 22 to 26 hours.

In the present invention, in the step of purifying unreacted monomers by precipitating the reaction solution in an alcohol, the reaction solution may be precipitated in an alcohol at a weight ratio of 1:3 to 5.

In the present invention, in the step of drying the SMA copolymer, heating may be performed at 40 to 60° C. for 13 to 17 hours.

In the present invention, in the step of preparing a copolymer mixture by mixing the SMA copolymer and GO, 0.5% to 10% by weight of the GO may be mixed based on 100% by weight of the copolymer mixture. As the content of the GO increases, various oxygen-containing functional groups, including —OH and —COOH, included in the GO may form stronger physical bonds through hydrogen bonding and electrostatic interactions with polymer chains, thereby increasing the thermoelectric decomposition temperature of the coating. In addition, more esterification reactions may occur, resulting in stronger chemical interactions with the polymers contained in the composition, thereby improving high-temperature stability. In addition, due to the high light absorption properties of GO, the higher the content of the GO, the more light may be absorbed, thus generating more heat.

When the GO is included in an amount exceeding 10% by weight, the viscosity of the coating composition may increase, making the coating process difficult. When the GO is included in an amount less than 0.5% by weight, the bonding with the polymer may become weak, and the photothermal effect may also be reduced.

In the present invention, the step of preparing a copolymer mixture by mixing the SMA copolymer and GO may include: a step of preparing a dispersion by adding GO to water and then dispersing; and a step of adding the SMA copolymer and a basic solution to the dispersion and then stirring and dispersing.

The step of preparing the copolymer mixture may result in a bonding between the GO and the maleic acid contained in the SMA copolymer through an esterification reaction. The reaction may be represented by the following [Scheme 3].

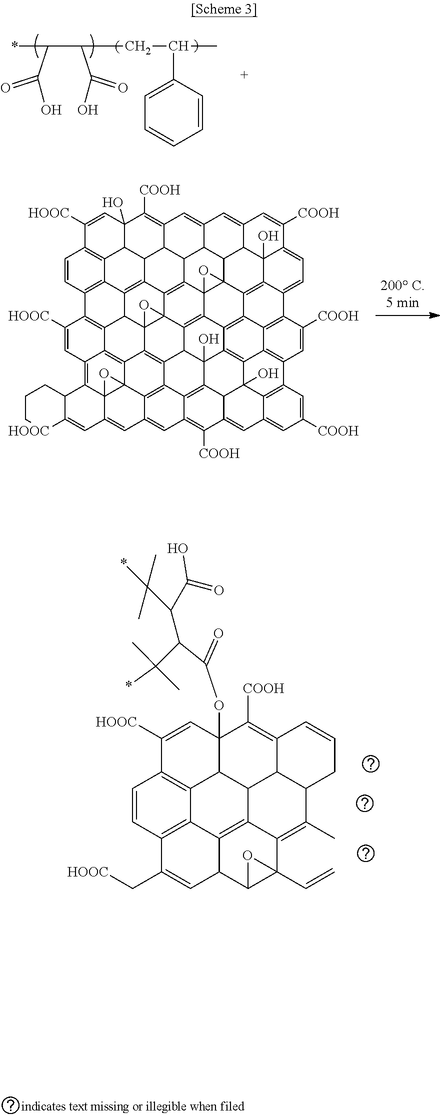

Due to the planar structure and strong bonding of the GO, movement between polymer chains may be further suppressed, resulting in a high glass transition temperature, thereby exhibiting excellent heat resistance and mechanical strength.

The step of adding the SMA copolymer and the basic solution to the dispersion and then stirring and dispersing may be performed to induce a ring-opening reaction of maleic anhydride using the basic solution, thereby introducing a carboxylic acid, which is a hydrophilic functional group, and enabling an eco-friendly coating using water as a solvent. The basic solution may preferably be ammonia water.

The GO is well dispersed in a polar solvent such as water and may be easily mixed with the hydrophilic polymer in a polar solvent.

In the present invention, in the step of adding the SMA copolymer and a basic solution to the dispersion and then stirring and dispersing, the basic solution may be added in a weight ratio of 1:0.3 to 0.9 based on the water.

In the present invention, in the step of preparing a coating composition by adding an alcohol to the copolymer mixture, the alcohol may be added in a weight ratio of 1:0.8 to 1.2 based on the water.

### EXAMPLES

Hereinafter, embodiments of the present invention will be described in detail, but it is obvious that the present invention is not limited to the following embodiments. The advantages and features of the present invention and methods for achieving them will become apparent with reference to the embodiments described in detail below together with the accompanying drawings. However, the present invention is not limited to the embodiments disclosed below, but may be implemented in various different forms, and the present embodiments are provided only to make the disclosure of the present invention complete and to fully inform those skilled in the art of the scope of the invention, and the present invention is defined only by the scope of the claims.

### <Example 1> Switchable Hydrophilic-Hydrophobic Copolymer (SMA Copolymer)

Azobicisobutyronitrile (AIBN), which is an initiator, styrene, and maleic anhydride were added to tetrahydrofuran (THF) solvent, and the resulting mixture was stirred in an oil bath at 70° C. for 24 hours. The resulting reaction solution was precipitated in methanol to purify the reaction solution from unreacted monomers. The purified reaction solution was vacuum filtered and dried in a vacuum oven at 50° C. for 15 hours to prepare an SMA copolymer. The addition ratios of the styrene and the maleic anhydride are shown in Table 1 below.

TABLE 1

| | Example 1-1 | Example 1-2 | Example 1-3 | Example 1-4 |
|---|---|---|---|---|
| Molar ratio | (SMA11) | (SMA21) | (SMA31) | (SMA41) |
| Styrene:maleic | 1:1 | 2:1 | 3:1 | 4:1 |
| anhydride | | | | |

### <Example 2> Eco-Friendly Anti-Icing Coating Solution Including a Switchable Hydrophilic-Hydrophobic Copolymer

GO was added to 2.5 ml of distilled water and then ultrasonically dispersed for 100 minutes using an ultrasonic processor. To the resulting GO dispersion, 500 mg of the SMA41 polymer prepared in Examples 1-4 and 1.6 ml of ammonia water were added. The mixture containing the polymer and ammonia water was ultrasonically dispersed for 200 minutes to prepare an anti-icing coating solution. The GO composition of the anti-icing coating solution is as shown in [Table 2] below.

TABLE 2

| (Based on | | | | |
|---|---|---|---|---|
| 100% by | Example 2-1 | Example 2-2 | Example 2-3 | Example 2-4 |
| weight of the | (SMA_GO | (SMA_GO | (SMA_GO | (SMA_GO |
| composition) | 0.5 wt %) | 1 wt %) | 3 wt %) | 5 wt %) |
| Amount of GO | 0.5% by | 1% by | 3% by | 5% by |
| | weight | weight | weight | weight |

### <Experimental Example 1> Structural Characterization of SMA Copolymers (NMR)

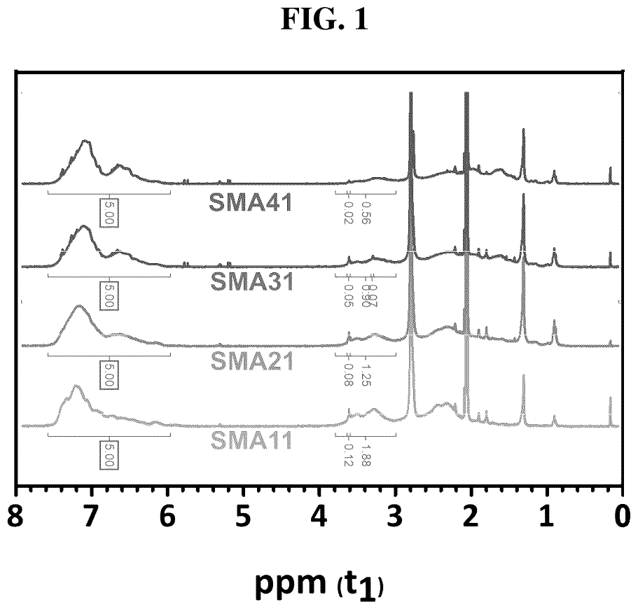

The SMA copolymer prepared in Example 1 was dissolved in acetone at a concentration of 5 mg/mL to prepare a copolymer solution. The copolymer solution was subjected to 1H-NMR analysis, and the maleic anhydride peak around 3 ppm and the styrene peak around 7 ppm were integrated to determine the monomer ratio. The results are shown in FIG. 1.

As shown in FIG. 1, the monomer ratio was 1.25:1 for Example 1-1 (SMA11), 2.04:1 for Example 1-2 (SMA21), 2.94:1 for Example 1-3 (SMA31), and 3.71:1 for Example 1-4 (SMA41). Through these results, it was confirmed that the copolymers were synthesized with ratios similar to their monomer ratios.

Through the above-described results, it was confirmed that a copolymer was successfully prepared according to the method for preparing the eco-friendly anti-icing coating composition including the switchable hydrophilic-hydrophobic copolymer according to the present invention.

### <Experimental Example 2> Thermal Characterization of SMA Copolymers

### <Experimental Example 2-1> Thermal Decomposition Temperature Measurement (TGA) of SMA Copolymers

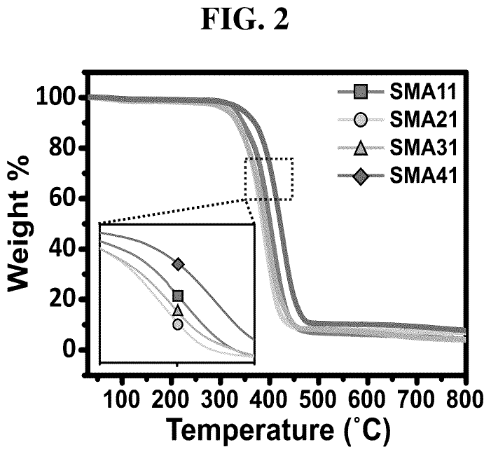

5 mg of the SMA copolymer prepared in Example 1 was heated from room temperature to 800° C. at a heating rate of 20° C./min under nitrogen conditions to determine the weight ratio (T_{d5%}). The results are shown in FIG. 2.

As shown in FIG. 2, the Td5% value was 346° C. for Example 1-1 (SMA11), 336° C. for Example 1-2 (SMA21), 334° C. for Example 1-3 (SMA31), and 370° C. for Example 1-4 (SMA41).

Through the above-described results, it was confirmed that the eco-friendly anti-icing coating composition including the switchable hydrophilic-hydrophobic copolymer according to the present invention, which includes a copolymer including styrene, exhibits excellent stability, excellent heat resistance, and high decomposition temperature even at high temperatures.

### <Experimental Example 2-2> Glass Transition Temperature Analysis (DSC) of SMA Copolymers

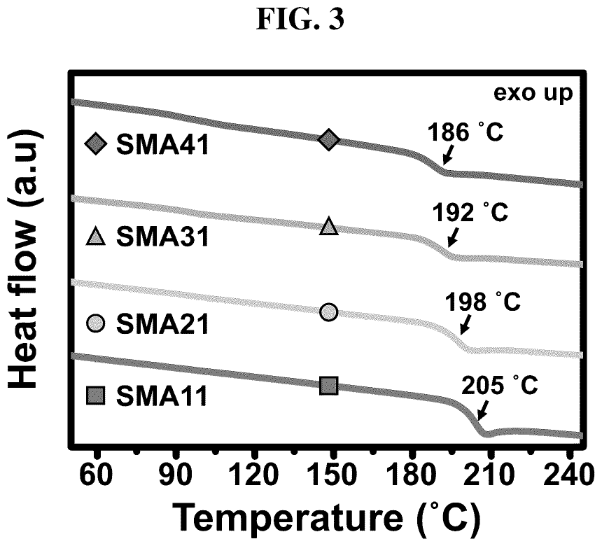

5 mg of the SMA copolymer prepared in Example 1 was placed on an aluminum pan and heated from room temperature to 250° C. at a heating rate of 20° C./min under nitrogen conditions using DSC equipment. The copolymer was then cooled to −40° C. and then heated to 250° C. The glass transition temperature (T_{g}) was measured, and the results are shown in FIG. 3.

As shown in FIG. 3, the glass transition temperature was 205° C. for Example 1-1 (SMA11), 198° C. for Example 1-2 (SMA21), 192° C. for Example 1-3 (SMA31), and 186° C. for Example 1-4 (SMA41). The results showed that the glass transition temperature increased as the maleic anhydride content increased.

Through the above-described results, it was confirmed that due to the maleic anhydride that has a polar structure compared to the styrene, which has a nonpolar structure, the eco-friendly anti-icing coating composition including the switchable hydrophilic-hydrophobic copolymer according to the present invention exhibits a high glass transition temperature because the hydrogen bonding and electrostatic interaction increase, which makes the arrangement between polymer chains denser and reduces chain mobility, thereby further suppressing the movement of molecular chains. It was also confirmed that a coating exhibiting excellent heat resistance and mechanical strength is formed through the above-described high glass transition temperature.

### <Experimental Example 3> Analysis of Hydrophilicity and Hydrophobicity Switching Properties of SMA Copolymers

### <Experimental Example 3-1> FT-IR Analysis

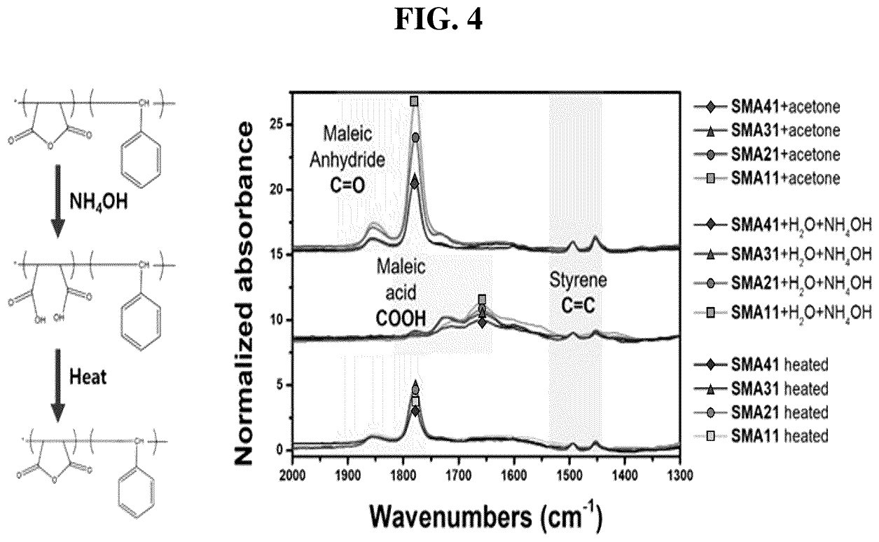

The SMA copolymer prepared in Example 1 was analyzed using FT-IR before and after the ring-opening reaction, and the results are shown in FIG. 4.

More specifically, the copolymer before the ring-opening reaction was prepared by dissolving 50 mg of the SMA copolymer prepared in Example 1 in 2 ml of acetone to prepare a coating solution, spin-coating the resulting solution on a glass substrate that had been plasma-treated for 10 minutes, drying it in a vacuum oven at 30° C. for two hours, and FT-IR measurement was performed. The copolymer after the ring-opening reaction was prepared by dissolving 50 mg of the SMA copolymer prepared in Example 1 in 0.75 ml of distilled water, 0.5 ml of ammonia water with a concentration of 20% to 30%, and 0.75 ml of ethanol to prepare coating solutions. The solutions were spin-coated on a glass substrate that had been plasma-treated for 10 minutes and then heated at 200° C. for five minutes. Thereafter, FT-IR measurement was performed.

As shown in FIG. 4, before the ring-opening reaction of the SMA copolymer prepared in Example 1, maleic anhydride peaks appeared at 1775 and 1850 cm⁻¹, and after the ring-opening reaction, maleic acid peaks appeared at 1660 and 1725 cm⁻¹. Furthermore, after the ring-closing reaction, maleic anhydride peaks appeared again at 1775 and 1850 cm⁻¹.

Through the above-described results, it was confirmed that the copolymer included in the eco-friendly anti-icing coating composition including the switchable hydrophilic-hydrophobic copolymer according to the present invention reversibly exhibited the ring-opening reaction and the ring-closing reaction.

### <Experimental Example 3-2> Water Solubility Analysis

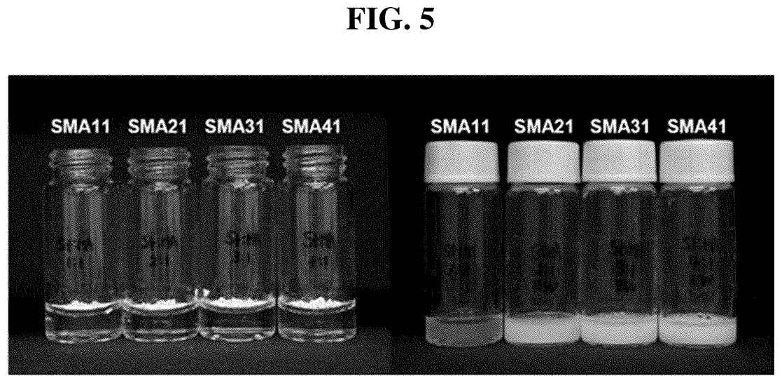

Photographs were taken after adding 50 mg of the SMA copolymer prepared in Example 1 to 0.75 ml of distilled water. Thereafter, 0.5 ml of ammonia water at a concentration of 25% to 30% was added to induce a ring-opening reaction. The results are shown in FIG. 5.

As shown in FIG. 5, the maleic anhydride included in the copolymer before the ring-opening reaction was induced was hydrophobic due to its cyclic structure, and thus it was insoluble in water. However, after adding ammonia water to induce the ring-opening reaction, the maleic anhydride was converted to maleic acid, generating hydrophilic functional groups so that the copolymer exhibited hydrophilicity and dissolved in water.

Through the above-described results, it was confirmed that the copolymer included in the eco-friendly anti-icing coating composition including the switchable hydrophilic-hydrophobic copolymer according to the present invention is readily soluble in water because the copolymer is converted to be hydrophilic through the ring-opening reaction.

### <Experimental Example 3-3> Contact Angle Analysis

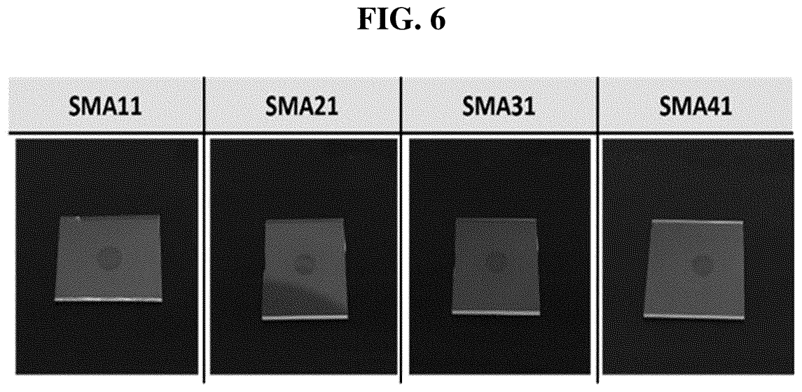

50 mg of the SMA copolymer prepared in Example 1 was added to 0.75 ml of distilled water, and then 0.5 ml of ammonia water at a concentration of 25% to 30% was added to induce a ring-opening reaction. The resulting solution was dropped onto a glass substrate, and the contact angle was analyzed. The results are shown in FIG. 6.

As shown in FIG. 6, when the solution containing the copolymer in which the ring-opening reaction was induced was placed on the substrate and dried, water droplet marks remained, confirming that the hydrophilic polymer was dissolved in water and the coating was peeled off.

### <Experimental Example 3-4> Contact Angle Measurement

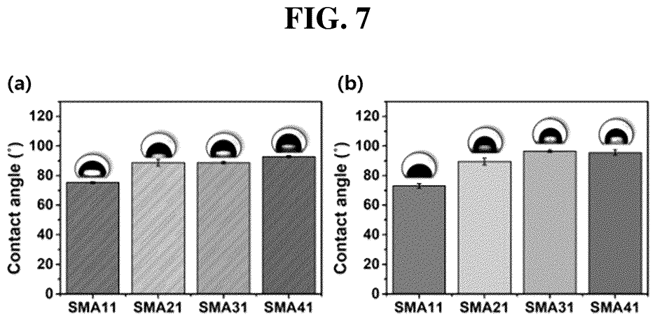

The contact angle of the solution containing the SMA copolymer prepared in Example 1, in which ring-opening and ring-closing reactions occurred, was measured, and the results are shown in FIG. 7.

More specifically, the copolymer before the ring-opening reaction was prepared by dissolving 50 mg of the SMA copolymer prepared in Example 1 in 2 ml of acetone, and the solution was spin-coated on a plasma-treated glass substrate for ten minutes and heated at 100° C. for five minutes. Thereafter, the contact angle was analyzed, and the results are shown in FIG. 7A.

In addition, the copolymer after the ring-closing reaction was prepared was prepared by adding 50 mg of the SMA copolymer prepared in Example 1 and then adding 0.5 ml of 25% to 30% ammonia water to induce the ring-closing reaction. The copolymer was spin-coated on a plasma-treated glass substrate for ten minutes and heated at 200° C. for five minutes. Thereafter, the contact angle was analyzed. The results are shown in FIG. 7B.

As shown in FIG. 7A, before the ring-closing reaction, the SMA copolymer of Example 1 exhibited hydrophobicity, with a contact angle greater than 90° on the surface. In addition, as shown in FIG. 7B, after the ring-closing reaction, the maleic acid in the SMA copolymer of Example 1 was converted back to maleic anhydride, resulting in a hydrophobic surface with a contact angle greater than 90°. Furthermore, the contact angle tended to increase as the proportion of styrene increased, and a similar contact angle was observed after the ring-closing reaction compared to the contact angle before the ring-opening reaction.

Through the above-described results, it was confirmed that the copolymer included in the eco-friendly anti-icing coating composition including the switchable hydrophilic-hydrophobic copolymer according to the present invention exhibits excellent properties of switching between hydrophilicity and hydrophobicity and that the hydrophobicity and hydrophilicity of the polymer can be controlled depending on the ratio of styrene and maleic anhydride.

### <Experimental Example 4> Analysis of Anti-Icing Coating Composition

### <Experimental Example 4-1> Esterification Reaction Analysis (FT-IR)

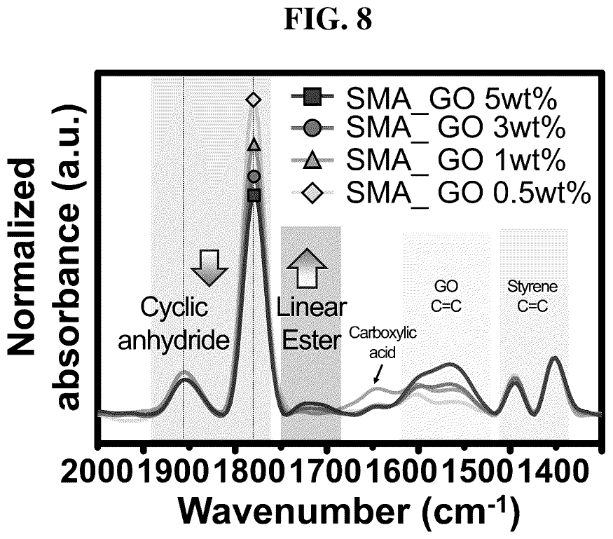

The coating solution prepared in Example 2 was spin-coated on a plasma-treated glass substrate for ten minutes and heated on a hot plate at 200° C. for five minutes to complete the coating. An FT-IR analysis of the coating was performed, and the results are shown in FIG. 8.

As shown in FIG. 8, it was found that the carboxylic acid group of maleic acid, which underwent a ring-opening reaction in the coating composition of Example 2, and the hydroxyl group of GO underwent an esterification reaction.

In addition, as the GO content increased, the cyclic anhydride peaks at 1850 and 1770 cm⁻¹ decreased, the linear ester peak at 1725 cm⁻¹ increased, and the OH peak of GO decreased, confirming that esterification occurred more as the GO content increased.

The above-described results confirmed that the method for preparing an eco-friendly anti-icing coating composition including the switchable hydrophilic-hydrophobic copolymer according to the present invention successfully produced a coating composition in which an SMA copolymer and GO are bonded by an esterification reaction therebetween.

### <Experimental Example 4-2> Thermal Performance Analysis (TGA)

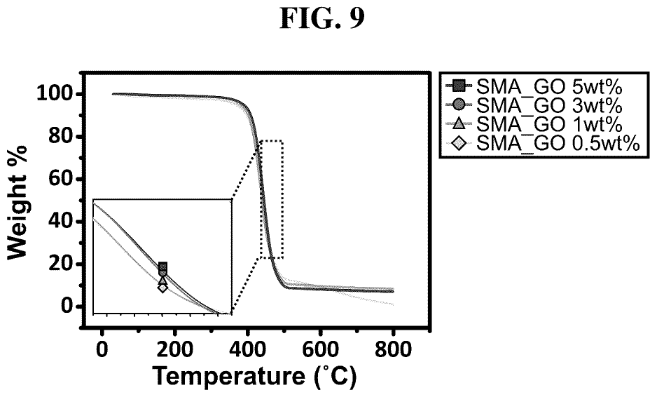

The coating solution prepared in Example 2 was dried in a vacuum oven at 100° C. for 15 hours, then processed using a hot press at 200° C. for 30 minutes to produce a film. Thereafter, 5 mg of the film was heated from room temperature to 800° C. under nitrogen conditions at a heating rate of 20° C./min to determine the weight ratio (T_{d5%}), and the results are shown in FIG. 9.

As shown in FIG. 9, the T_{d5%} was 398° C. for the film including Example 2-1 (SMA_GO 0.5 wt %), 402° C. for the film including Example 2-2 (SMA_GO 1 wt %), 409° C. for the film including Example 2-3 (SMA_GO 3 wt %), and 409° C. for the film including Example 2-4 (SMA_GO 5 wt %), indicating that the T_{d5%} values were increased by more than 30° C. compared to that of the SMA41 copolymer of Example 1-4, which was 370° C. In addition, it was shown that the thermal decomposition temperature of the polymer composite coating increased as the content ratio of GO increased.

Through the above-described results, it was confirmed that the eco-friendly anti-icing coating composition including the switchable hydrophilic-hydrophobic copolymer according to the present invention forms a strong physical bond through hydrogen bonding and electrostatic interactions with the polymer chains through various oxygen-containing functional groups, including —OH and —COOH, contained in GO, thereby increasing the thermal decomposition temperature of the coating, and exhibiting excellent high-temperature stability and a high thermal decomposition temperature.

### <Experimental Example 4-3> Thermal Performance Analysis (DSC)

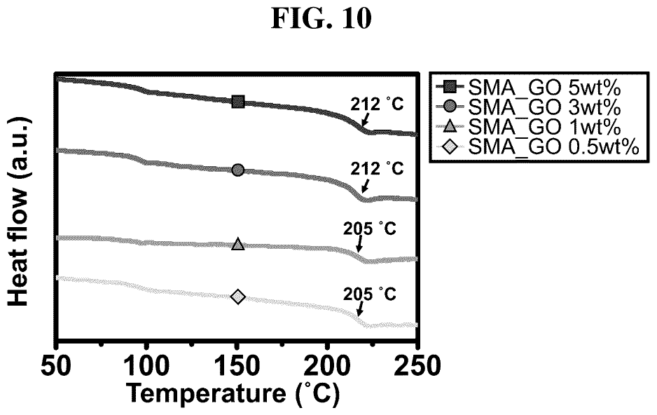

The coating solution prepared in Example 2 was dried in a vacuum oven at 100° C. for 15 hours and then processed using a hot press at 200° C. for 30 minutes to produce a film. Thereafter, 2 mg of the film was heated from room temperature to 250° C. under nitrogen conditions using DSC equipment at a heating rate of 20° C./min. The film was then cooled to −40° C. and then reheated to 250° C. to determine the glass transition temperature (T_{g}). The results are shown in FIG. 10.

As shown in FIG. 10, the glass transition temperature was 205° C. for the film including Example 2-1 (SMA_GO 0.5 wt %), 205° C. for the film including Example 2-2 (SMA_GO 1 wt %), 212° C. for the film including Example 2-3 (SMA_GO 3 wt %), and 212° C. for the film including Example 2-4 (SMA_GO 5 wt %), indicating that the glass transition temperature values were increased by more than 20° C. compared to that of the SMA41 copolymer of Example 1-4, which was 186° C.

Through the above-described results, it was confirmed that the eco-friendly anti-icing coating composition including the switchable hydrophilic-hydrophobic copolymer according to the present invention exhibits a high glass transition temperature due to the planar structure and strong bonding of GO, which further suppresses movement between polymer chains. In addition, it was confirmed that a coating exhibiting excellent heat resistance and mechanical strength was formed through the above-described high glass transition temperature.

### <Experimental Example 4-4> Mechanical Performance Analysis (Pencil Hardness Test)

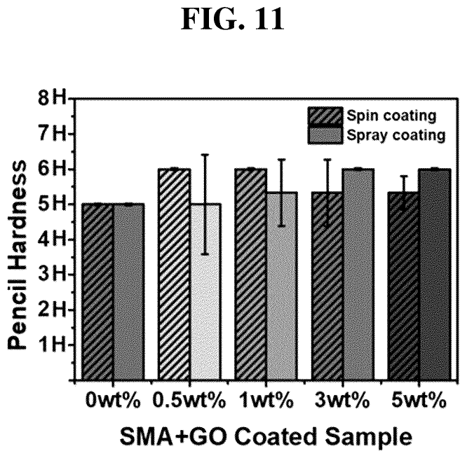

1 ml of the coating solution prepared in Example 2 was spin-coated, and 0.3 ml was spray-coated. The coating was then heated on a hot plate at 200° C. for five minutes to form a coating. A pencil with a hardness ranging from 2B to 7H, including a black core protruding 1 to 2 mm and having a right-angled tip sharpened using sandpaper, was then placed on the coating surface. A constant load of 1 kgf was applied, and the pencil was slowly moved horizontally. Scratch marks on the coating surface were examined under a microscope, and the surface hardness was determined based on a pencil left no damage on the surface. The results are shown in FIG. 11.

As shown in FIG. 11, the coating including the coating solution of Example 2 exhibited a high hardness of 6H.

Through the above-described results, it was confirmed that the eco-friendly anti-icing coating composition including the switchable hydrophilic-hydrophobic copolymer according to the present invention can form a coating exhibiting excellent mechanical performance through hydrogen bonding and electrostatic interactions of various oxygen-containing functional groups of GO and esterification reaction with the SMA copolymer.

### <Experimental Example 5> Analysis of Anti-Icing Performance of Anti-Icing Coating Composition

### <Experimental Example 5-1> Photothermal Effect Analysis (Photothermal Test)

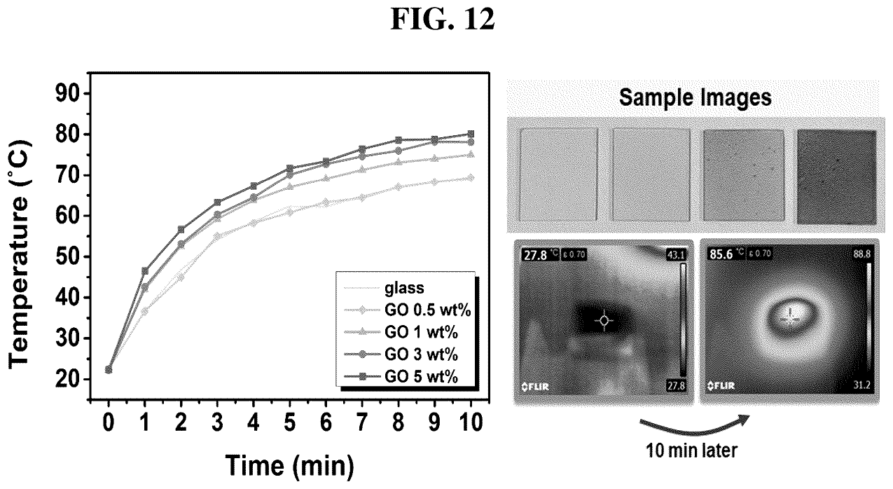

0.3 ml of the coating solution prepared in Example 2 was spray-coated onto a glass substrate and heated on a hot plate at 200° C. for five minutes to form a coating. The coating was irradiated with light at an intensity of 0.1 W/cm² using a solar simulator, with an emissivity set to 0.7 to compensate for the reflectance of the glass surface. The temperature change was measured every minute for 10 minutes using a thermal imaging camera, and the results are shown in FIG. 12.

As shown in FIG. 12, the photothermal effect was enhanced as the GO content increased. In particular, the coating formed by using the coating solution of Example 2-4 (SMA_GO 5 wt %), which had a high GO content, showed a temperature increase of more than 10° C. compared to a standard glass substrate.

Through the above-described results, it was confirmed that the eco-friendly anti-icing coating composition including the switchable hydrophilic-hydrophobic copolymer according to the present invention exhibits an excellent photothermal effect by efficiently absorbing light and converting a large amount of energy into heat due to the large surface area and high light absorption properties of GO.

### <Experimental Example 5-2> Analysis of Icing Occurrence Time in the Absence of Light (Icing Test)

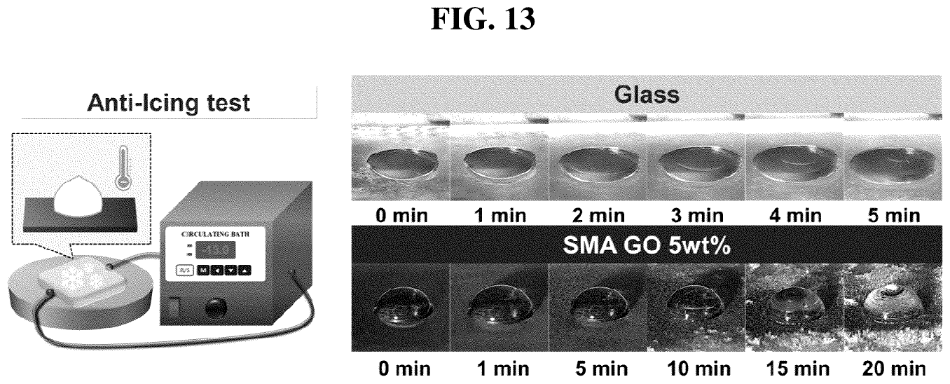

0.3 ml of the coating solution prepared in Example 2-4 was spray-coated onto a glass substrate and heated on a hot plate at 200° C. for five minutes to form a coating. The coating and the glass substrate were then cooled to −13° C. using a cooling circulator to measure the icing time. The results are shown in FIG. 13.

As shown in FIG. 13, icing of the standard glass substrate occurred in five minutes, while icing of the coating formed by using the coating solution prepared in Example 2-4 occurred in 20 minutes.

The above-described results confirm that the eco-friendly anti-icing coating composition comprising the switchable hydrophilic-hydrophobic copolymer according to the present invention exhibits excellent icing delay performance due to the hydrophobic coating, which creates air pockets and reduces contact area and thermal conductivity.

### <Experimental Example 5-3> Analysis of Icing Occurrence Time in the Presence of Light (Anti-Icing Test)

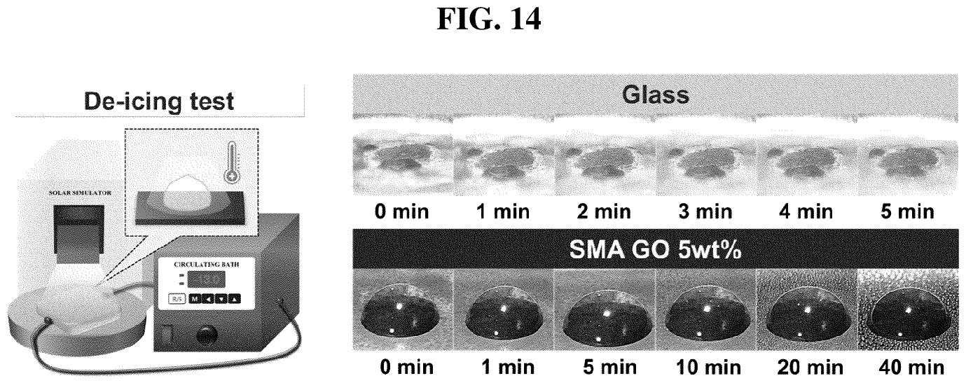

0.3 ml of the coating solution prepared in Example 2-4 was spray-coated onto a glass substrate. The coating was then heated on a hot plate at 200° C. for five minutes to form a coating. The coating and the glass substrate were then cooled to −13° C. using a cooling circulator. The icing time was measured using a solar simulator while irradiating the substrate with sunlight at 0.1 W/cm². The results are shown in FIG. 14.

As shown in FIG. 14, icing occurred on the standard glass substrate in five minutes, but icing of the coating formed by using the coating solution prepared in Example 2-4 did occur even after 40 minutes.

Through the above-described results, it was confirmed that the eco-friendly anti-icing coating composition including the switchable hydrophilic-hydrophobic copolymer according to the present invention exhibits excellent anti-icing performance through the photothermal effect of GO and the icing delay performance of the hydrophobic coating.

### <Experimental Example 5-4> Waterproofing Property Analysis (UV-VIS Spectroscopy)

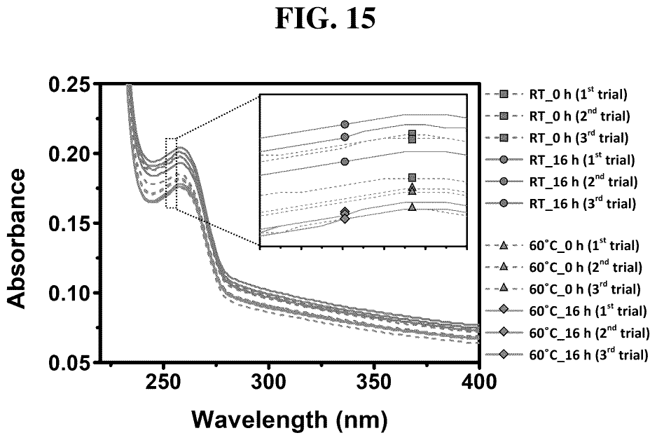

0.3 ml of the coating solution prepared in Example 2-4 was spray-coated onto a glass substrate, which was then heated on a hot plate at 200° C. for five minutes to form a coating. The substrate with the coating formed thereon was immersed in 20 ml of distilled water at room temperature and 60° C. for 16 hours. The coating status before and after immersion was measured using a UV-VIS spectrometer in the wavelength range of 200 to 400 nm. The results are shown in FIG. 15.

As shown in FIG. 15, the absorbance peak at 258 nm of the substrate including the coating formed by using the coating solution prepared in Example 2-4 did not show a significant change before and after 16 hours of immersion.

Through the above-described results, it was confirm that the eco-friendly anti-icing coating composition including the switchable hydrophilic-hydrophobic copolymer according to the present invention forms a coating exhibiting excellent waterproofing properties and stability.

By solving the above-described problems, the present invention can provide an eco-friendly anti-icing coating composition including a switchable hydrophilic-hydrophobic copolymer capable of switching hydrophilicity and hydrophobicity of the polymer itself and a method for preparing the same.

Furthermore, the present invention can provide an eco-friendly anti-icing coating composition that is in a hydrophilic state during a coating process and thus readily dissolves in water, enabling an eco-friendly and simple process, after which functional groups are converted into hydrophobic functional groups to exhibit excellent waterproofing properties and durability, and a method of preparing the same.

Furthermore, the present invention can provide an eco-friendly anti-icing coating composition that includes GO and thus exhibits a photothermal effect of increasing temperature by absorbing light to exhibit excellent anti-icing performance, and a method for preparing the same.

Furthermore, the present invention can provide an eco-friendly anti-icing coating composition capable of rapidly preventing and removing ice and controlling anti-icing performance in extreme environments, and a method for preparing the same.

Furthermore, the present invention can provide an eco-friendly anti-icing coating composition, which has excellent anti-icing performance and thus can be used to prevent performance degradation and damage in various fields where ice formation frequently occurs, such as aircraft wings, wind turbine blades, and power lines, and a method for preparing the same.

The effects of the present invention are not limited to those mentioned above, and other effects that are not mentioned will be clearly understood to those skilled in the art from the description of the claims.

The anti-icing coating composition according to the present invention combines hydrophobic anti-icing coating technology with a photothermal effect to exhibit excellent anti-icing performance by delaying icing and even melting existing ice for easy removal of ice from surfaces. Therefore, the present invention is suitable for widespread application in various industrial fields.

Furthermore, the use of water as a solvent, rather than organic solvents, minimizes environmental impact and facilitates the implementation of a simple coating process. Therefore, it is expected that the present invention can contribute to mitigating environmental pollution issues and enhancing commercial productivity for sustainable industrial operations.

1. An eco-friendly anti-icing coating composition including a switchable hydrophilic-hydrophobic copolymer, the composition comprising:
a styrene-maleic anhydride (SMA) copolymer including styrene and maleic anhydride; and
graphene oxide (GO).

2. The eco-friendly anti-icing coating composition including a switchable hydrophilic-hydrophobic copolymer according to claim 1, wherein the SMA copolymer is represented by the following [Chemical Formula 1]:

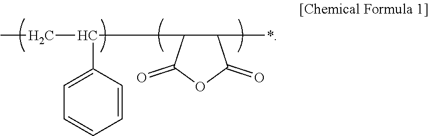

3. The eco-friendly anti-icing coating composition including a switchable hydrophilic-hydrophobic copolymer according to claim 1, wherein the SMA copolymer includes the styrene and the maleic anhydride in a molar ratio of 1 to 4:1.

4. The eco-friendly anti-icing coating composition including a switchable hydrophilic-hydrophobic copolymer according to claim 1, wherein the SMA copolymer reversibly exhibits a ring-opening reaction and a ring-closing reaction.

5. The eco-friendly anti-icing coating composition including a switchable hydrophilic-hydrophobic copolymer according to claim 4, wherein the ring-opening reaction occurs when the coating composition is added to a basic solution and stirred.

6. The eco-friendly anti-icing coating composition including a switchable hydrophilic-hydrophobic copolymer according to claim 4, wherein the ring-closing reaction occurs when the coating composition is heated at 180 to 220° C. for three to seven minutes.

7. The eco-friendly anti-icing coating composition including a switchable hydrophilic-hydrophobic copolymer according to claim 1, wherein the coating composition includes 0.5% to 10% by weight of the GO based on 100% by weight of the coating composition.

8. A method for preparing an eco-friendly anti-icing coating composition including a switchable hydrophilic-hydrophobic copolymer, the method comprising:
a step of preparing a styrene-maleic anhydride (SMA) copolymer;
a step of preparing a copolymer mixture by mixing the SMA copolymer and graphene oxide (GO); and
a step of preparing a coating composition by adding an alcohol to the copolymer mixture.

9. The method for preparing the eco-friendly anti-icing coating composition including a switchable hydrophilic-hydrophobic copolymer according to claim 8, wherein the step of preparing the SMA copolymer includes:
a step of preparing a reaction solution by adding styrene, maleic anhydride, and an initiator to a polar organic solvent and then heating and stirring;
a step of purifying unreacted monomers by precipitating the reaction solution in an alcohol;
a step of obtaining an SMA copolymer by filtering the reaction solution purified from unreacted monomers; and
a step of drying the SMA copolymer.

10. The method for preparing the eco-friendly anti-icing coating composition including a switchable hydrophilic-hydrophobic copolymer according to claim 9, wherein the polar organic solvent is tetrahydrofuran (THF), and the initiator is azobisisobutyronitrile (AIBN).

11. The method for preparing the eco-friendly anti-icing coating composition including a switchable hydrophilic-hydrophobic copolymer according to claim 9, wherein, in the step of preparing the reaction solution, the styrene and the maleic anhydride are added in a molar ratio of 1 to 4:1 and then heated and stirred.

12. The method for preparing the eco-friendly anti-icing coating composition including a switchable hydrophilic-hydrophobic copolymer according to claim 9, wherein, in the step of preparing the reaction solution, heating is performed to 60 to 80° C. and stirring is performed for 22 to 26 hours.

13. The method for preparing the eco-friendly anti-icing coating composition including a switchable hydrophilic-hydrophobic copolymer according to claim 9, wherein, in the step of purifying unreacted monomers by precipitating the reaction solution in an alcohol, the reaction solution is precipitated in an alcohol in a weight ratio of 1:3 to 5.

14. The method for preparing the eco-friendly anti-icing coating composition including a switchable hydrophilic-hydrophobic copolymer according to claim 9, wherein, in the step of drying the SMA copolymer, heating is performed at 40 to 60° C. for 13 to 17 hours.

15. The method for preparing the eco-friendly anti-icing coating composition including a switchable hydrophilic-hydrophobic copolymer according to claim 8, wherein, in the step of preparing a copolymer mixture by mixing the SMA copolymer and GO, 0.5% to 10% by weight of the GO is mixed based on 100% by weight of the copolymer mixture.

16. The method for preparing the eco-friendly anti-icing coating composition including a switchable hydrophilic-hydrophobic copolymer according to claim 8, wherein the step of preparing a copolymer mixture by mixing the SMA copolymer and GO includes:
a step of preparing a dispersion by adding GO to water and then dispersing; and
a step of adding the SMA copolymer and a basic solution to the dispersion and then stirring and dispersing.

17. The method for preparing the eco-friendly anti-icing coating composition including a switchable hydrophilic-hydrophobic copolymer according to claim 16, wherein, in the step of adding the SMA copolymer and a basic solution to the dispersion and then stirring and dispersing, the basic solution is added in a weight ratio of 1:0.3 to 0.9 based on the water.

18. The method for preparing the eco-friendly anti-icing coating composition including a switchable hydrophilic-hydrophobic copolymer according to claim 8, wherein, in the step of preparing a coating composition by adding an alcohol to the copolymer mixture, the alcohol is added in a weight ratio of 1:0.8 to 1.2 based on the water.
